(19) United States
(12) Patent Application Publication
(10) Pub. No.: US 2023/0366605 A1
(43) Pub. Date: Nov. 16, 2023

(54) POWERED STORAGE AND TRANSPORTATION CASE

(71) Applicant: Brandon T. Witkowski, Saginaw, MI (US)

(72) Inventor: Brandon T. Witkowski, Saginaw, MI (US)

(21) Appl. No.: 17/663,061

(22) Filed: May 12, 2022

(51) Int. Cl. F25D 11/00; B65D 81/38; B65D 25/28

(52) U.S. Cl. CPC F25D 11/00; B65D 81/3816; B65D 25/2835

(57) ABSTRACT

A powered storage and transportation case comprised of a composite that is powered for cooling for the preservation of game.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention is a powered storage and transportation case. The applicant is aware of the following prior art in the field.

Various powered storage and transportation cases and related devices are known in the art. For example, U.S. Pat. No. 10,588,311 entitled, “Sealable Animal Carcass Enclosement Systems and Methods”, issued to Raynal on Mar. 17, 2020, teaches a sealable animal carcass enclosement system including a substantially planar foldable envelope made of a vinyl coated mesh material, sealing securements along an edge of some of the sides of the substantially planar foldable envelope when in the open state, and application components configured to guide overlapping closure of the substantially planar foldable envelope and matching of counterparts of the sealing securements so as to provide an enclosed packet for animal carcasses.

In another example, U.S. Pat. No. 6,557,353 entitled, “Apparatus and Method for Cooling An Object” issued to Fusco on May 6, 2003, teaches a thermoelectric apparatus that includes a power source, a body having a first side and a second side with a defined perimeter wherein the first side and the second side are separated by a gap. It further includes an insulation means for providing a thermal barrier, a cooling means placed between the first and the second side for cooling an object and a connecting means for securing the body into a defined shape around an object

A method of operating a thermoplastic apparatus includes wrapping a body around an object, with the body having a first side and a second side, a defined perimeter and the first side and second side separated by a gap containing an insulation means that forms a thermal barrier. Another step is engaging a connecting means for securing the body into a defined shape around the object, engaging a power source and then operating a cooling means placed between the first side and the second side of the body in the gap for cooling the object.

U.S. Pat. No. 6,508,077 entitled, “Collapsible Cooler For Game”, issued to Vander Boegh et al., on Jan. 21, 2003, teaches a collapsible cooler that is configured to hold perishable foods on ice while in the field such as freshly killed big game. The cooler is formed of an outer layer and an inner layer of waterproof nylon fabric with two intermediate layers of heat resistant insulation. In a closed configuration, the cooler is secured and drawn together via a set or mating series of hook and loop fasteners to form an aperture for exposing the neck and head portion of the captured big game. In this configuration, a carcass of the captured game is kept cool and fresh from a surrounding stream of cold air. A natural drain is formed at the base of the cooler to allow for natural flow of fluid from the cooler to allow for natural flow of fluid from the cooler to a surrounding area.

U.S. Pat. No. 10,816,128 entitled, “Thermal Insulation Liner”, issued to McGoff et al., on Oct. 27, 2020, teaches products, methods, and kits for use in regulating the temperature of an object. The present invention relates to thermal insulating liners for regulating the temperature of perishable goods or temperature sensitive products. The thermal insulating liners generally may be quickly dimensioned to fit within a container. The thermal insulating liners may be quickly collapsed and reconstructed to improve stickability and diminish the amount of space required to store the thermal insulating liners prior to use.

U.S. Pat. No. 10,731,910 entitled, “Portable Cooler” issued to Lockwood on Aug. 4, 2020, teaches a portable cooler that includes a base that supports a refrigeration unit. The base also supports a plurality of upwardly extending support poles that accommodate a top portion. The support poles, top portion, and base define a food storage volume that is surrounded by a plurality of insulated walls.

U.S. Pat. No. 9,939,188 entitled, “Portable Cooler” that issued to Lockwood on Apr. 10, 2018, teaches a portable cooler that includes a base that supports a refrigeration unit. The base also supports a plurality of upwardly extending support poles that accommodate a top portion. The support poles, top portion, and base define a food storage volume that is surrounded by a plurality of insulated walls.

U.S. Pat. No. 7,338,210 entitled, “Big Game Storage and Transportation Bag”, issued to Fultz et al., on Mar. 4, 2008, teaches a storage and transportation mechanism for game animals after they have been killed. The storage and transportation mechanism is a nylon bag with a top mounted opening that can be folded back for placement of both dead game animals and volumes of ice to keep the dead game animals preserved for longer periods of time. Furthermore, the bag has a plurality of external nylon carrying straps and also extra storage room for antlers, should this feature be needed.

None of the prior art references teach nor make obvious the instant invention.

### BRIEF SUMMARY OF THE INVENTION

The present invention is a powered storage and transportation case. The transportation case comprises a composite. This composite comprises a coolant manifold layer selected from the group consisting of, in a first embodiment, an interlayered tubing, in a second embodiment, two layers of material thermoformed together to form linear conduits in the material, and in a third embodiment, a composite wherein there are two layers of material thermoformed together to form linear conduits in the material wherein the conduits contain a tubing.

In each embodiment, there is an insulating layer surmounted on the coolant manifold layer selected from the group consisting of closed cell foam and insulating fibers and a water impermeable layer selected from: rubber, canvas, and waterproof treated fabric. All the layers of the composite are reinforced around outer edges of the layers to form the composite.

There is at least one support and carrying strap affixed to the storage and transportation case, a liquid cooling unit, and a reservoir for storing liquid coolant. There also is a pump for pumping the liquid coolant through the cooling unit and the composite and a motor for driving the pump. There is also piping for circulating the liquid coolant from the reservoir and to and through said coolant manifold layer and return to said reservoir.

### BRIEF DESCRIPTION OF THE SEVERAL VIEWS OF THE DRAWING(S)

FIG. 1 is a full side view of a powered storage and transportation case of this invention.

FIG. 2 is a full end view of the powered storage and transportation case of this invention.

FIG. 3 is a full top view of the coolant manifold layer of the powered storage and transportation case of this invention with interlayered tubing.

FIG. 4 is a full top view of a coolant manifold layer of the powered storage and transportation case of this invention with two layers of material thermoformed together to form linear conduits in the material

FIG. 5 is a full top view of a coolant manifold layer of the powered storage and transportation case of this invention with two layers of material thermoformed together to form linear conduits in the material wherein the conduits contain an internal tubing.

### DETAILED DESCRIPTION OF THE INVENTION AND DRAWINGS

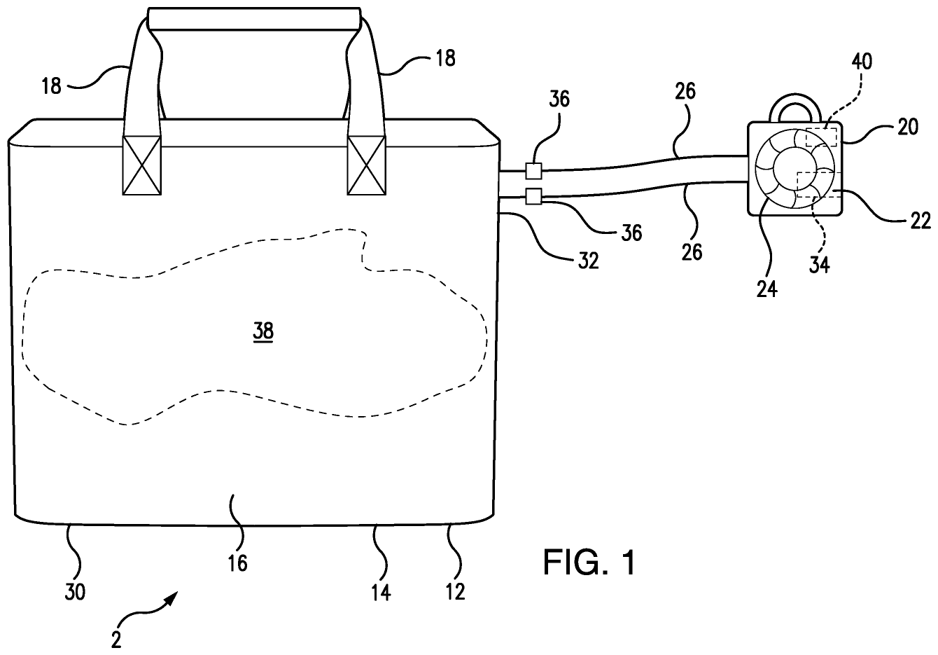

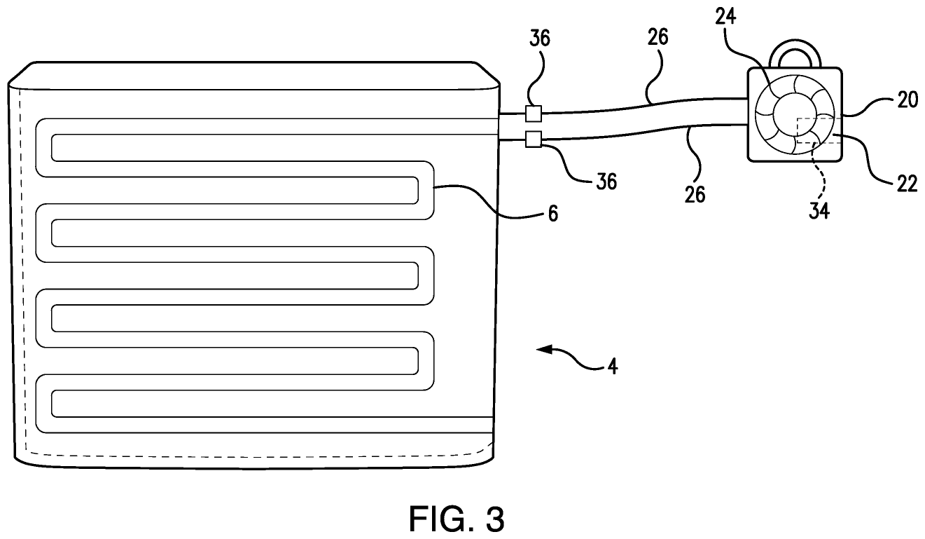

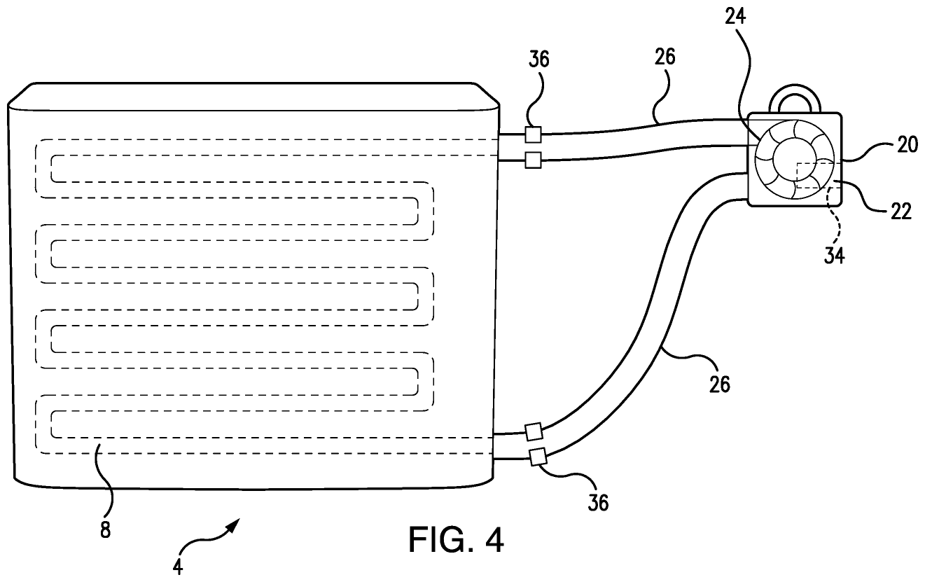

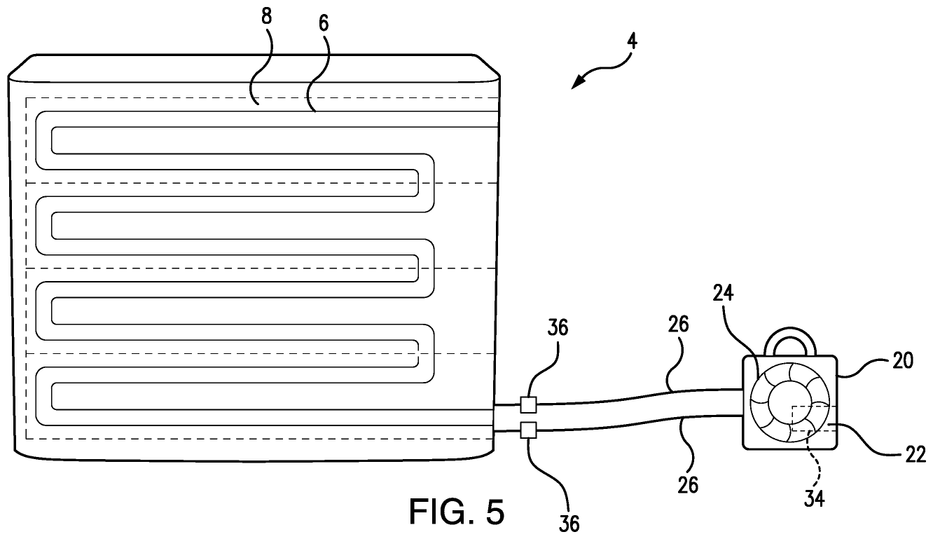

FIG. 1 is a full side view of the powered storage and transportation case 2 of the instant invention. The transportation case 2 comprises a composite case 30. This composite case 30 comprises a coolant manifold layer 4 selected from the group consisting of, in a first embodiment, an interlayered tubing 6 (FIG. 3), in a second embodiment two layers of material thermoformed together to form linear conduits 8 in the material (FIG. 4), and in a third embodiment, two layers of material thermoformed together to form linear conduits 8 in the material wherein the conduits contain a tubing 6 (FIG. 5).

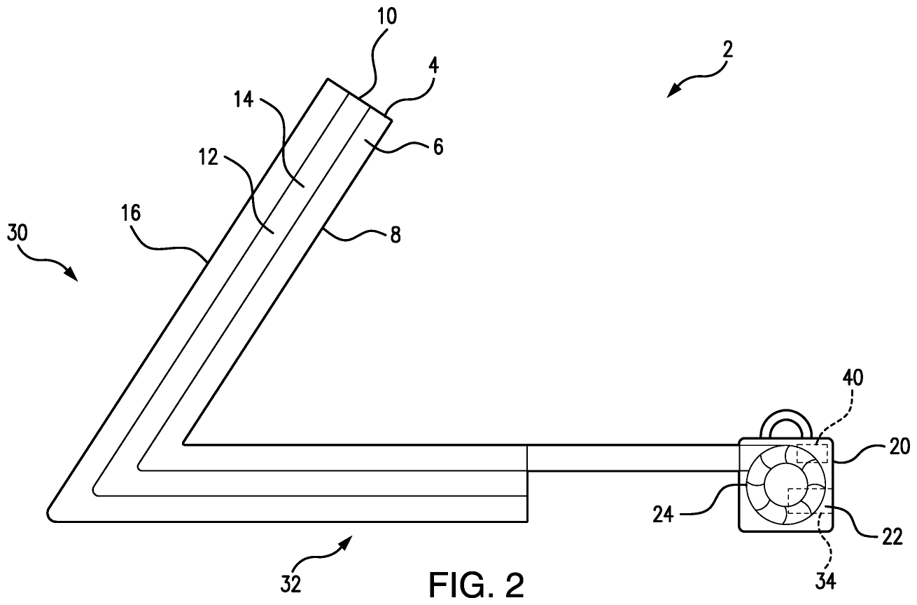

Turning to FIG. 2, there is an insulating layer 10 surmounted on the coolant manifold layer 4 selected from the group consisting of closed cell foam and insulating fibers. There is a water impermeable layer 16 selected from rubber, canvas, and waterproof treated fabric. All the layers of the composite 4 are reinforced around outer edges 32 of the layers to form the composite case 30.

There is at least one support and carrying strap 18 affixed to the storage and transportation case 2. There is also a liquid cooling unit 20 and a reservoir 22 (shown in phantom in FIGS. 1 and 2) for storing liquid coolant 34. There also is a pump 24 for pumping the liquid coolant 34 through the cooling unit 20 and the composite case 30. There is also piping 26 for circulating the liquid coolant 34 from the reservoir 22 through the coolant manifold layer 4.

The device is a cooling unit 20 separate from the composite case 2, the cooling unit 20 has a reservoir 22 and a circulation pump 24 that provides constant circulation of coolant 34 through the cooling unit 20 and through the composite case 2 around the animal 38. The pump 24 is energized by and is driven by an electric motor 40 (shown in FIGS. 1 and 2) and is contained in the cooling unit 20.

The composite case 2 consists of a durable outermost layer 16 such as duck canvas and the innermost layer is composed of two layers 8 and 10 of thermoplastic urethane or similar material that has been thermoformed together creating a chamber of random flow of current that is consistently circulating back to the cooling unit 20. In the encapsulated tube embodiment, the two layers 8 and 10 of plastic can be thermoformed around silicone tubing 6 at one edge with the silicone tubing 6 that has quick connect adapters 36 to easily separate the case 2 from cooling unit 20. There can also be a closed cell insulation 12 used as a layer between the plastic and the canvas. The powered storage and transportation case 2 keeps that game animal 38 at a constant cool temperature.

All the layers of the composite case 30 are reinforced around outer edges 32 of the layers to form the composite case 30 by stitching or gluing.

Again, the cooling unit 20 provides coolant 34 from the reservoir 22 that is supplied by the pump 24 that flows through the piping 26 that has quick disconnect connectors 36. The coolant 34 passes through the piping 26 to the tubing 6 within the composite 30. The cooling unit 20 maintains a constant cool temperature of the coolant 34 that is circulating within the powered storage and transportation case 2. A game animal 38 is placed within the powered storage and transportation case 2 and is kept cool. It has been discovered that the cooling of freshly taken game provides a safe means to transport that game without spoilage.

What is claimed is:

1. A powered storage and transportation case, said transportation case comprising:
A. a composite, said composite comprising:
i. a coolant manifold layer selected from the group consisting of:
a. interlayered tubing;
b. two layers of material thermoformed together to form linear conduits in said material;
c. two layers of material thermoformed together to form linear conduits in said material wherein said conduits contain a tubing;
ii. an insulating layer surmounted on said coolant manifold layer selected from the group consisting of;
a. closed cell foam, and,
b. insulating fibers;
iii. a water impermeable layer selected from:
a. rubber,
b. canvas, and,
c. waterproof treated fabric, wherein all said layers of said composite are reinforced around outer edges of said layers to form said composite;
B. at least one support and carrying strap affixed to said storage and transportation case;
C. a liquid cooling unit;
D. a reservoir for storing liquid coolant;
E. a pump for pumping said liquid coolant through said cooling unit and said composite, said pump being powered by an electric motor;
F. piping for circulating said liquid coolant from said reservoir to and through said coolant manifold layer and return to said reservoir.

2. A powered storage and transportation case as claimed in claim 1 wherein the insulating layer is selected from closed cell foam.

3. A powered storage and transportation case as claimed in claim 1 wherein the insulating layer is selected from insulating fiber.

4. A powered storage and transportation case as claimed in claim 1 wherein the water impermeable layer is rubber.

5. A powered storage and transportation case as claimed in claim 1 wherein the water impermeable layer is canvas.

6. A powered storage and transportation case as claimed in claim 1 wherein the water impermeable layer is waterproof treated fabric.

7. A powered storage and transportation case as claimed in claim 1 wherein all layers of the composite case are reinforced around outer edges of the layers to form the composite.
